(19) United States
(12) Patent Application Publication
(10) Pub. No.: US 2005/0083289 A1
(43) Pub. Date: Apr. 21, 2005

(54) [CASCADE DRIVING CIRCUIT FOR LIQUID CRYSTAL DISPLAY]

(76) Inventor: CHIH-HSIANG YANG, TAOYUAN COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,446

(22) Filed: Mar. 4, 2004

(30) Foreign Application Priority Data
Oct. 21, 2003 (TW) 92129090

(51) Int. Cl. G09G 3/36; G08C 19/00; G08C 25/00

(52) U.S. Cl. 345/100; 345/87

(57) ABSTRACT

A cascade driving circuit for a liquid crystal display, including a plurality of driving circuit units, a plurality of differential signal transmitters and a plurality of differential signal receivers. Each of the driving circuit units is disposed with one of the differential signal transmitter, so as to generate a differential signal and propagate which to next stage for each driving circuit unit. Each of the driving circuit units is further disposed with one of the differential signal receivers, so as to receive the differential signal from the previous stage of the driving circuit unit. Therefore, power consumption is reduced with usage of differential signals.

### CROSS REFERENCE TO RELATED APPLICATIONS

This application claims the priority benefit of Taiwan application No. 92129090, filed on Oct. 21, 2003.

### BACKGROUND OF INVENTION

1. Field of the Invention

This invention generally relates to a driving circuit for liquid crystal display, and more particularly to a cascade driving circuit.

2. Description of Related Art

The driving circuit for a liquid crystal display (LCD) in conventional scheme is primarily categorized into parallel driving circuit and cascade driving circuit. A parallel driving circuit transmits data signal to designated driving circuit unit via bus, thus it takes substantially large layout and routing area on a printed circuit board.

Referring FIG. 1, a parallel driving circuit structure is illustrated herein. The data signal 122 of the LCD 110 in the figure is supplied by a plurality of driving circuit units 120, which are manufactured with Tape Carrier Package (TCP) technology. The driving circuit units 120 supplies primitive data signal 144 via data bus 142, and the data signal 144 is transmitted to designated driving circuit unit 120 via data bus 142 controlled by a timing controller 140. The foregoing data bus 142 and the timing controller 140 are both disposed on a printed circuit board 130. Since bus structure and timing controller are included, significant layout and routing area on the printed circuit board 130 are required. Therefore, cascade style driving circuit is developed upon pursuing miniature in electronic products.

A cascade driving circuit is connected from a plurality of driving circuit units. The type of circuit transmits data signal to designated driving circuit unit stage by stage.

Referring to FIG. 2, a cascade driving circuit structure is described herein. The data signal 222 for the LCD 210 in the figure is supplied by a plurality of driving circuit units 220, which is formed via Chip On Glass (COG) technology on LCD substrate 210. The timing controller 240, being disposed on the PCB 230, generates cascade signal 224 and transmits which to a designated driving unit 220 stage by stage via the cascade structure of the driving circuit units 220. The transmitting channel of the cascade signal 224 is formed on the LCD substrate 210 with Wire On Array (WOA) technology.

Referring to FIG. 3, a characteristic of cascade 310 to another cascade 330 via WOA wire 320 is illustrated as a signal attenuation diagram herein.

Since cascade driving circuit is disposed on LCD substrate and WOA technology is applied to connecting wires between each of the driving circuit units, large impedance is inevitable, as well as signal attenuation and major power consumption.

### SUMMARY OF INVENTION

An object of the present invention is to provide a driving circuit for LCD, so as to reduce power consumption of the conventional cascade driving circuit.

Another object of the present invention is to provide a driving circuit for LCD, so as to improve signal attenuation of the conventional cascade driving circuit.

A differential signal interface circuit is provided in this present invention, for disposing between cascade driving circuit units for reducing power consumption.

Another signal amplifier is provided in this present invention, so as to reduce signal attenuation.

A cascade LCD driving circuit is provide in this present invention, including a plurality of driving circuit units, a plurality of differential signal transmitters, and a plurality of differential signal receivers. The driving circuit units are connected in a cascade fashion, and a data signal is generated for driving the LCD. One of the differential signal transmitters is disposed to each of the driving circuit units, so as to generate differential signals for driving a next stage of the driving circuit unit. One of the differential signal receivers is disposed with each of the driving circuit units, so as to receive a differential signal from the previous stage of the driving circuit unit.

In one preferred embodiment of the present invention, the foregoing differential signal transmitter further includes a signal amplifier, which converts and amplifies the differential signal before transmitting the differential signal from the differential transmitter.

Since a differential signal interface circuit is disposed between the driving circuit units, the differential signal interface circuit includes a differential signal transmitter being disposed in the timing controller, and a differential signal transmitter and a receiver being disposed in each of the driving circuit units. Since the differential signal transmits signals with differentiating a positive signal and its inverse negative signal, voltage is lowered as well as power consumption is reduced comparing to conventional transmission method via voltage variation.

According to another preferred embodiment of the present invention, since the primitive differential signal is partially amplified after conversion, signal attenuation is compensated in advance during transmission, where a signal amplifier is disposed with differential signal transmitter among each of the driving circuit unit and the timing controller.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a structure diagram illustrating a parallel driving circuit according to a conventional scheme.

FIG. 2 is a structure diagram illustrating a cascade driving circuit according to a conventional scheme.

FIG. 3 is a waveform diagram illustrating signal attenuation as data transmitted according to a conventional scheme.

FIG. 4 is a block diagram illustrating a driving circuit unit according to one preferred embodiment of the present invention.

FIG. 5 is circuit diagram illustrating a differential signal interface circuit according to one preferred embodiment of the present invention.

FIG. 6 is a block diagram illustrating a driving circuit unit including signal amplifier according to one preferred embodiment of the present invention.

FIG. 7 is a waveform diagram illustrating signal amplification according to one preferred embodiment of the present invention.

FIG. 8 is a circuit diagram illustrating the signal amplifier according to one preferred embodiment of the present invention.

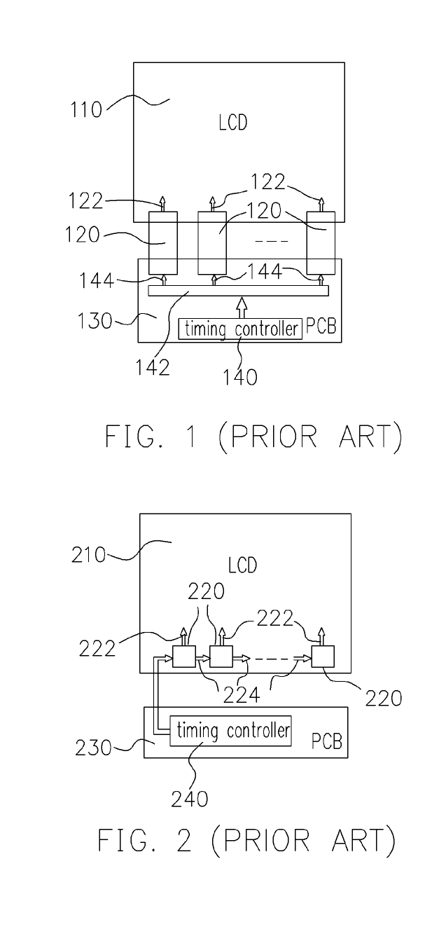

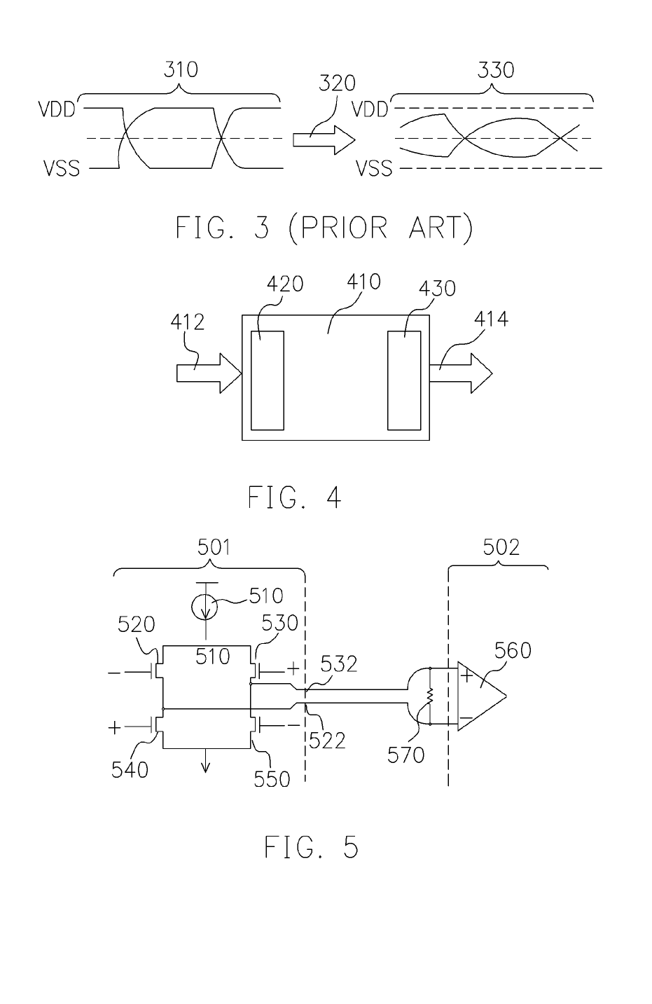

### DETAILED DESCRIPTION

Referring to FIG. 4, it is a block diagram illustrating a driving circuit unit according to one preferred embodiment of the present invention. A differential signal 412 is transmitted from a previous stage to a present stage, and is read to a driving circuit unit 410 via a differential signal receiver 420, and generating a differential signal 414 which is transmitted to a next stage thereafter via a differential signal transmitter 430,

The aforementioned differential signal transmitter 430 and the receiver 420 are illustrated as shown in FIG. 5. In the figure, the drains of the transistor 520 and transistor 530 are coupled to the current source 510, the source of the transistor 520 is coupled to the drain of the transistor 520 where an output signal 522 is drawn, the source of the transistor 530 is coupled to the drain of the transistor 550 where output signal 532 is drawn, and the sources of the transistor 540 and of the transistor 550 are coupled to ground voltage. The signal 522 and the signal 532 make the differential signal that is transmitted by the differential transmitter 501. The differential signal receiver 502 couples the signal 522 to a first end of the resistor 570 and the negative terminal of the amplifier 560, and couples the signal 532 to a second end of the resistor 570 and the positive terminal of the amplifier 560.

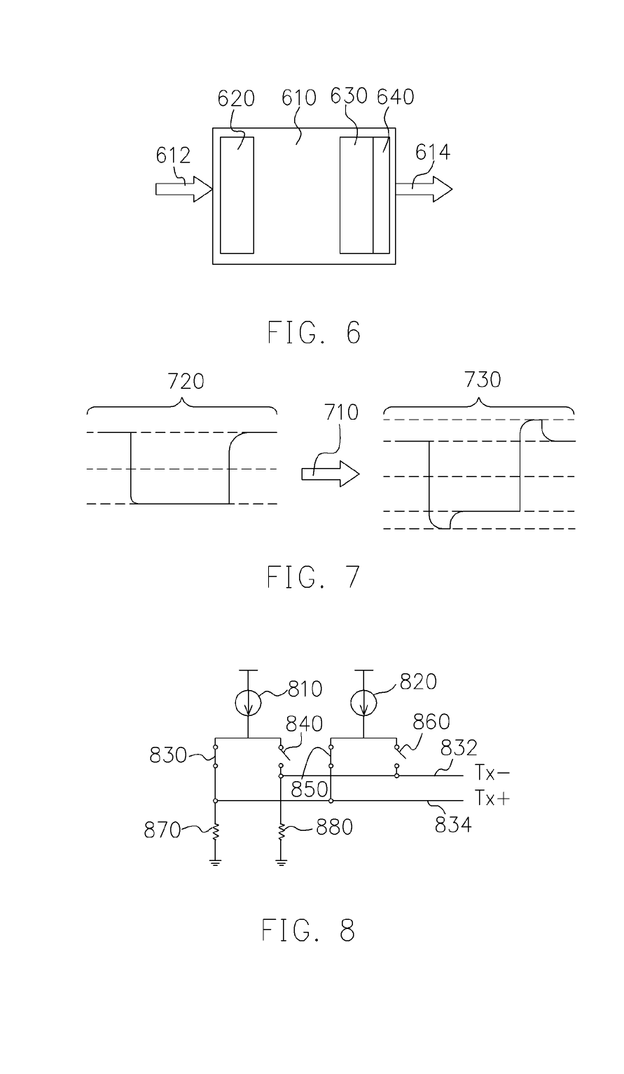

Another preferred embodiment is provided in this present invention for eliminating signal attenuation during conventional differential signal transmission. Referring to FIG. 6, it is a block diagram illustrating a driving circuit unit including a signal amplifier. A differential signal 512 is propagated from a previous stage to this present stage, and is read to the driving circuit unit 610 via the differential signal receiver 620. Thereafter, the differential signal transmitter 630 generates a differential signal, which is converted and partially amplified by the signal amplifier 640, and a differential signal 614 is obtained and transmitted to a next stage thereby.

Referring to FIG. 7, it is a waveform diagram of signals that are amplified by the amplifier. The differential signal 720 in the figure is amplified by the amplifier 710 in one preferred embodiment of the present invention, a differential signal 730 is obtained amplified.

The signal amplifier in the foregoing second preferred embodiment is implemented in FIG. 8. The current source 810 and current source 820 supply the current that is required by signal amplifier. The second terminals of the resistors 870 and 880 are coupled to ground voltage respectively. The first terminals of the sensor switches 830 and 840 are coupled to the current source 810, the first terminals of the sensor switches 850 and 860 are coupled to the current source 820, the second terminals of the sensor switches 830 and 850 are coupled to the first terminal of the resistor 870 where the signal 834 is drawn, and the second terminals of the sensor switches 840 and 860 are coupled to the first terminal of the resistor 880 where the signal 832 is drawn. The signal 834 and 832 make the differential signal that is transmitted by the signal amplifier. Wherein, if the primitive signal is converted and amplified partially for front end, the sensor swtemptempitches 830 and 850 are turned on whereas the sensor switches 840 and 860 are turned off. For non-partial amplification, sensor switches 830 and 860 are turned on whereas sensor switches 840 and 850 are turned off.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A cascade liquid crystal display (LCD) driving circuit, comprising:
a plurality of driving circuit units, coupling in cascade fashion, for outputting a data signal to drive a LCD;
a plurality of differential transmitters, for generating a differential signal and transmitting which to a next stage of the driving circuit unit, each of the driving circuit units being disposed with one of the differential transmitters; and
a plurality of differential receivers, for receiving differential signal from a previous stage of the driving circuit units, each of the driving circuit being disposed with one of the differential receivers.

2. The cascade LCD driving circuit as recited in claim 1, wherein the differential signal transmitter comprises:
a current source, for providing current that is required by the differential signal transmitter; and
a first transistor, a second transistor, a third transistor, and a fourth transistor, wherein a drain of the first transistor and a drain of the second transistor are coupled to the current source, a source of the first transistor is coupled to a drain of the third transistor where a first signal is drawn, a source of the second transistor is coupled to a drain of the fourth transistor where a second signal is drawn, sources of the third and the fourth transistors are coupled to ground voltage, and the first signal associated with the second signal is the differential signal.

3. The cascade LCD driving circuit as recited in claim 1, wherein the differential signal transmitter comprises a signal amplifier, which converts and partially amplifies the differential signal before the differential signal is transmitted from the differential signal transmitter.

4. The cascade LCD driving circuit as recited in claim 3, wherein the amplifier comprises:
a first current source and a second current source;
a first resistor and a second resistor, a second terminal of the first resistor and a second terminal of the second resistor are coupled to ground voltage; and
a first sensor switch, a second sensor switch, a third sensor switch, and fourth sensor switch, a first terminal of the first sensor switch and a first terminal of the second sensor switch are coupled to the first current source, a first terminal of the third sensor switch and a first terminal of the fourth sensor switch are coupled to the second current source, a second terminal of the first sensor switch and a second terminal of the third sensor switch are coupled to a first terminal of the first resistor where a first signal is drawn, a second terminal of the second sensor switch and a second terminal of the fourth sensor switch are coupled to the a first terminal of the second resistor where a second signal is drawn, the first signal associated with the second signal is the differential signal that is amplified, wherein
if performing amplification, the first sensor switch and the third sensor switch are turned on, and the second sensor switch and the fourth sensor switch are turned off, and
if not performing amplification, the first sensor switch and the third sensor switch are turned of, and the second sensor switch and the fourth sensor switch are turned on.
